(19) United States
(12) Patent Application Publication
(10) Pub. No.: US 2004/0111350 A1
(43) Pub. Date: Jun. 10, 2004

(54) PROCESS TO CREATE MARKET-SECTOR INVESTMENT PORTFOLIO PERFORMANCE INDICES

(75) Inventor: James Allen Charnley JR., Barrington, RI (US)

Correspondence Address: BARLOW, JOSEPHS & HOLMES, LTD., 101 DYER STREET, 5TH FLOOR, PROVIDENCE, RI, 02903, US

(73) Assignee: WATER STREET ADVISERS, INC., Barrington, RI (US)

(21) Appl. No.: 10/604,711

(22) Filed: Aug. 12, 2003

Related U.S. Application Data
(60) Provisional application No. 60/403,235, filed on Aug. 14, 2002.

(51) Int. Cl. G06F 17/60

(52) U.S. Cl. 705/36

(57) ABSTRACT

The method of generating a market-sector level index of investment portfolio performance includes the steps of acquiring data for a population of investments and generating a contiguous series of the measurement of periodic investment returns for the population of investments whose operations mirror that of an investment manager holding a diversified investment portfolio. The population of investments is divided into market-sector groups whose pattern and level of past periodic returns has been uniquely different as stipulated under the tenets of Modern Portfolio Theory. The population average of period-returns is calculated for each period within the contiguous series and each market-sector group. Measures of index-comparison and population-comparison statistics are created for each market sector from periodic returns averages of the market sector groups . The measure of index-comparison is preferably calculated using the formula of: [(ending value-preceding period)*(1+(average periodic return-current period/100))]=[ending value-current period]. The measure of population-comparison is preferably calculated using the tenets of the Capital Assets Pricing Model and a measure of the index population absolute periodic returns variance to benchmark investment risk.

### CROSS REFERENCE TO RELATED APPLICATIONS

This application claims the benefit of U.S. Provisional Application Serial No. 60/403,235, filed Aug. 14, 2002.

### BACKGROUND OF INVENTION

In the field of securities and investments, an investment performance index is a measurement benchmark made from calculating a contiguous series of averages for the periodic investment returns generated by members of a population of securities or a sample population of securities. This is the process employed by providers of existing indices for populations of primary-market securities (stocks and bonds), as well as, populations of secondary-market securities (mutual funds, variable annuities and other book-valued collections of primary securities that offer ownership shares) that have been aggregated at investment-objective or market-category levels. Indices are used primarily for evaluating the relative performance of investments and investment management functions. It is in regard to this second evaluative purpose, the assessment of the relative value of an investment management functions, that these existing performance indices fall short, creating evaluative findings that are skewed, incomplete and biased for market conditions.

Investors hire investment managers to manage investment portfolios. A manager of an investment portfolio is required to perform three functions. His primary function is to select for a strategy of allocating the assets of an investment portfolio among securities from different “market-sectors” in order to provide a diversified risk. Because of the computational limitations inherent in constructing populations of allocation-strategy alternatives and the constraints imposed by the tenets of Modern Portfolio Theory (MPT), the market-sectors defined within an asset-allocation strategy are necessarily broad, few in number and inclusive of all markets.

There exist two other management functions that are necessary corollaries to choosing an allocation strategy in that these are the functions required to actually implement that strategy through the selection of investment assets. The second management function involves a further process of asset diversification, which is selecting for a portfolio of investments from within each market-sector whose investment performance, as a group, will be a faithful and efficient representation of the investment performance anticipated by the selected allocation strategy. To be of additive value, this faithful and efficient representation needs to meet two minimum requirements. First, the portfolio of investments selected from within the market sector must be faithful to the level of investment return expected from the allocation strategy by producing a level of investment return that is at least equal to the level that could be achieved by the random selection of an investment from within the market sector. Second, the selected portfolio must be an efficient risk by operating at a level of investment risk that is less than the level that could be achieved by the random selection of an investment from within the market sector, for after all, as a diversification procedure, this function”s only constructive value lies in its ability to minimize investment risk for an expected return.

The third function is to select for investments with which to populate this group whose future investment returns will be strong relative to their market-sector peers. This is a selection function that relies on special knowledge of future differences in investment performance characteristics between individual investments within a market sector to produce its additive value, and is a selection process that is the antithesis of the other two diversification procedures.

In the prior art, there exist a multitude of commercial processes for evaluating the success of managers at this third function, namely, processes that will judge the relative strength of individual investment selections. Most of these processes use indices as benchmark measures, and they are constructed to provide exacting and specific benchmarks of market peers for these investments.

Providers of processes for evaluating the first of these corollary functions, which is selecting for a diverse group of investments within a market-sector that provide for an efficient risk, are a much smaller group. These providers utilize the same population of available indices as formulated for evaluating individual investment choices, which causes a problem. The existing benchmark measures, which are comprised of indices for groups of primary-market securities and for investment-objective and market-category groupings of secondary-market securities-, are not sufficient for the task, because they have been constructed to reveal exacting and specific distinctions between individual investment choices. Their purpose is to judge the performance of individual investment selections against a narrowly defined population of their peers. A primary-market index represents a single alternative for creating a portfolio from the population of stocks or bonds that may be available within a market sector. Secondary-market indices formed at the market-category and investment objective levels represent alternatives for creating a portfolio from only a limited subset of the stocks or bonds that may be available within a market sector. Their strength relies on their specificity, and their levels of investment return and investment risk are in constant flux relative to the average levels of return and risk generated by the market sector population. They therefore cannot be relied upon to consistently measure the management functions of providing a selection of market sector investments that are a faithful and efficient representation of the investment performance expected of an allocation strategy selection, because they each only represent a single option or single set of options available for the manager function of selecting for a portfolio of investments from within each market-sector. Benchmarking the efficiency of this function using these narrow groupings of market sector peers creates an evaluative measure that is characteristically incomplete, skewed and biased for market conditions.

An investment portfolio is created when an investor elects to hold more than one investment asset at a period in time. Investors hold more than one investment asset as a hedge against the uncertainty of accurately forecasting the future path of investment markets and the future investment performance of those assets. Given the prevailing skepticism among investors and industry practitioners of the possibility of consistently predicting the future path of investment markets and of the future performance of individual investments, the creation of investment portfolios remains a common practice for investment management.

The selection and evaluation processes in general use within the investment management industry operate under the tenets of Modern Portfolio Theory (MPT), a thesis written by Dr. Harry Markowitz to define the functions of portfolio management in terms of the characteristics of investor demand. In MPT, investment return is calculated as the average of a contiguous series of periodic investment returns (mean). Investment risk is defined as the variance of those periodic returns around that average (variance). Investment performance is defined in terms of investment return as a function of investment risk, and is commonly illustrated as a two-dimension graph, known as a “mean-variance” graph, as seen in FIG. 1. The mean-variance graph of FIG. 1 plots an investment”s performance as a function of the average of a series of periodic investment returns (y-axis) and the variance of those periodic returns around their average (x-axis). Under the tenets of Modern Portfolio Theory, investor demand is satisfied at a point of maximum average return for a level of returns variance.

For example, in the mean-variance graph in FIG. 1 investment B is less risky than investment A and C. Investment C has generated greater investment returns than investment B and A. It therefore can be said that investment A has the weakest investment performance of the three investments and is least likely to satisfy investor demand.

The management of an investment portfolio entails three functions. First, a strategy is selected for diversifying the portfolio assets among market-sectors that have historically provided dissimilar investment risk. In terms of MPT, this process entails selecting for a strategy to allocate those assets among market-sectors whose population of investments have exhibited a pattern and level of periodic-returns variance that are uniquely dissimilar to the patterns and levels of periodic-returns variance of populations of investments within other market sectors-. The thesis of MPT is that the combination of these dissimilar risks ensures a portfolio that will generate the maximum average return for a level of returns variance.

The product of this process is a strategy outlined in terms of the percentage of portfolio assets to be allocated to investments of each market-sector, the total of which adds up to 100% of portfolio assets (for example, in a strategy made from five market sectors, 10% Aggressive-risk market-sector assets, 20% Above Average-Risk market-sector assets, 40% Average-Risk market-sector assets, 20% Low-risk market-sector assets and 10% Contrarian-risk market-sector assets). The processes for this function are beyond the scope of the present invention.

Once an allocation strategy has been formulated in terms of market sectors, the second management function is to select for one or more investments within each sector whose future pattern and level of periodic returns will reflect the pattern and level expected, on average, for the population of investments within the market sector. The population of investments within a market sector is known as an “asset class”. For those portfolio managers possessing less than perfect foresight regarding the future pattern and level of periodic returns for the investments available within an asset class, this function is accomplished through a second level of diversification. A portfolio of investments from within the class is selected on the basis that their future pattern and level of periodic returns, as a group, will reflect that of the asset class population. Because, as a general rule, investment managers possess less than perfect foresight, creating diversified portfolios from a plurality of investments at the market-sector level is the common method employed by the industry for ensuring that the investments chosen within a market-sector actually reflect the anticipated risk and returns of that sector. This diversification process, to be of additive value must perform to two criteria, which are that the selected portfolio must generate an investment return that is at least as strong as that expected from the random selection of an investment from the class, and that it must operate at a level of investment risk below that produced by that random selection.

The third function of managing an investment portfolio is to select for investments whose future investment returns will be strong relative to their asset class peers. There exist numerous commercial providers of this function, both in terms of selection, as well as, evaluative processes. The processes for this function are also beyond the scope of the present invention. FIG. 2 is a schematic view that illustrates how these three functions fit together.

There have been many attempts in the prior art to improve upon measures to evaluative the relative performance of the three functions mentioned above. For example, the current trend for manufacturers of primary-market securities indices, as well as investment-objective and market-category indices of secondary-market securities, is to increase the population of these indices and make the populations of investments they describe smaller. This “focusing” process is in response, in large part, to investor and industry demand for evaluative benchmarks that will more accurately predict the performance of managers in implementing the third portfolio management function, which is the selection of individual investments whose future performance will be strong relative to their asset-class peers, by more finely defining the range of investment performance outcomes that could possibly result from future market conditions.

U.S. Pat. No. 6,021,397, issued to Jones et al., entitled “Financial Advisory System” addressed these issues. In this patent, a factoring process is utilized to create an index from the combination of primary-market securities indices that is specifically tailored to that individual investment. Each investment alternative has is own unique benchmark that indicates whether the investment performance generated by this alternative is stronger than that expected from a combination of the specific markets factors that influence that performance.

Also, Micropal, a subsidiary of Standard and Poors Inc. and a provider of mutual fund performance indices lists (61) investment objective and (23) market-category averages. Lipper, a subsidiary of Reuters Inc. and another commercial provider of indices, lists (19) market-category indices for funds investing in domestic equities alone (about ½ of the total funds market). For funds indices, the trend mirrors that of the primary-market securities market, namely, more and narrower benchmark populations for indices, as seen in FIG. 10.

These primary-market indices and secondary-market indices of the size of market and investment objective categories define subsets within market sector populations of investments and investment managers that, if aggregated at the market sector level, would complement a strategy for dividing the market into a small set of broad market-sectors suitable for constructing asset-allocation strategies. However, none of these indices, of and by themselves, are suitable benchmarks for the evaluation of investment portfolio management that employs diversification as a market sector investment strategy. Asset allocation strategies because of the constraints on computing power can only be selected from a population of alternatives constructed from a limited number of market-sectors. The consideration of the number of allocation strategies constructed from only (10) market-sectors in increments of 5-percent each entails a population of over 7 million alternatives. This condition necessitates that investment managers construct their market-sector portfolios from the options available within broad asset-classes that contain large populations of investments. Indices built as a collection of primary-market securities are representative of only a single option for combining these market-sector investments into a portfolio. Indices built as a collection of secondary-market securities aggregated at the investment-objective or market-category level are representative of only a single type of option among a plurality available to a manager for combining the investments within an asset class. These selections cannot be said to be representative of the performance characteristics of that class or indicative of an unbiased measurement of the act of selecting a portfolio from the class. Clearly, the recent trend toward creating indices in greater numbers and indicative of narrower market segments is aimed at a different investor than that is concerned about effectively managing an investment portfolio.

In addition to Jones, et al. there exists one other patent that purports to rate the value of an investment or investment portfolio. U.S. Pat. No. 5,784,696, issued to Melnikoff, entitled “Methods and Apparatus for Evaluating Portfolios Based on Investment Risk” proposes to calculate the suitability of investments selected for a portfolio using a measurement based on their historical downside volatility (chance of loss). An index measurement is not offered in his process. However, the application does make mention of Morningstar, Inc. and other database providers that offer a proprietary system for ranking mutual funds based on their history of periodic returns volatility. The index used for the Morningstar methodology is the yield on a short-term Treasury. Morningstar, Melnikoff and others rate individual investments on the basis of their consistency in bettering the yield on a short-term Treasury over time.

In view of the foregoing, the prior art does not solve the problems associated with correctly measuring the effectiveness of investment managers. More specifically, the effectiveness of investment managers in performing these three functions is evaluated by computing their investment performance at each of these three levels and comparing this performance to some recognized benchmark measure of investment performance. This is the central activity of processes to evaluate investment managers and the investment portfolios they manage.

There does not exist a benchmark that correctly measures the effectiveness of investment managers in their performance of the second investment-management function, namely, selecting for a suitably diverse portfolio of investments from among the population of investments available within a market sector.

Industry benchmarks are most commonly structured as indices where performance measurements are calculated from a population”s or a population-sample”s periodic returns. The industry has long relied on indices calculated from populations of primary-market securities (e.g. stocks and bonds) as a benchmark of manager performance. As referenced above, these indices are not appropriate benchmarks of a management function to provide for a diversified investment portfolio at the market sector level because they identify only one portfolio option among a myriad of options available. This condition creates the potential for possible skewness and market-condition bias in the evaluative findings based on these types of benchmarks. As shown in FIG. 5, this potential for skewness is actually a systemic condition owing to the fact that these primary-market indices generally operate at much higher levels of investment risk than would a corresponding population of investment managers, on average, within a market sector. This higher level of investment risk is because of the practical differences between holding a collection of primary securities and holding a portfolio of primary securities that must be managed for liquidity and diversification issues. These practical differences mean that an index constructed solely as a collection of primary-market securities will always operate at a higher level of risk than the average for a market-sector population of investment portfolios made from these securities. This systemic condition of higher risk creates problem for the primary-market indices. They can provide a critical benchmark for measuring for the special talents of those managers to select for market sector investments whose investment returns will be higher than average in those analysis periods when the overall strength of the market favors a narrowly-defined selection criteria that successfully follows that market strength. They are worthless as benchmarks when the overall strength of the market weakens or when their narrowly-defined investment population does not follow the path of market strength. In their present construction as narrowly-defined groups of investments, these attributes mean that indices of primary-market securities are the least appropriate of the methods available to benchmark a manager”s function to provide for a diversified risk at the market-sector level. In FIG. 5 a critical benchmark of these diversification efforts would be one whose level of investment risk would always appear to the left of the market-sector average for population investment risk on a mean-variance graph, such as characteristic of the point labeled “sec port”. The characteristic position of the primary-market index to the right of this sector-average (“prime-sec index”) marks it as a particularly unsuitable benchmark for measuring market-sector diversification.

The population of investment managers that operate mutual funds are a subset of the population of secondary-market securities and benchmarks made from the investment performance characteristics of these mutual funds are a convenient and stable sample population for the general population of investment managers maintaining market-sector level portfolios. There exist commercial providers of “investment-objective” and “market-category” indices made from the performance data of populations of mutual fund managers. As shown in FIGS. 6 and 7, these indices measure average performance of only small subsets of market-sector populations (there exist multiples of investment-objective and market-category populations within a market-sector) and are unsuitable to the task of evaluating market-sector level diversification because their measurements are too narrow to capture the market-sector average in all market conditions.

In FIG. 6 and 7, it is also demonstrated that narrow indices constructed for subsets of funds within a market-sector, namely, market-category or investment objective indices, are also unsuitable because of the variance in their position vis-a-vis the sector average over the phases of a market cycle. This market-phase variance is characteristic of a benchmark that generates evaluative findings that are skewed and biased for market conditions.

As referenced above, the required attributes of the diversification function at the market-sector level are that it results in a level of investment returns that can be expected from the random selection of an investment from that asset class and that it generate a level of investment risk that is below the level expected from that random selection. The investment return and risk from a random selection from an asset class population is calculated as the averages for the investment returns and investment risks generated by the members of that population. In FIG. 6 and 7, this average is identified as the point “sec avg.”. These figures chart the performance of the (5) market-category indices of populations of mutual funds provided by Micropal that reside within the Above-Average Risk market-sector for two successive 3-year periods, 1994-96 and 1997-99. These two analysis periods represent two phases within a market cycle and the variance in the performance of these market-category indices relative to the sector-average demonstrates the measurement inconsistencies inherent with selecting for a narrow index to represent an asset class population. In contrast, the point of performance for the present method, marked as “sec port” over these two market-cycle phases demonstrates its unique quality to act as a critical and unbiased benchmark of the market-sector diversification function.

The way in which indices are commonly constructed makes them unique in their ability to illustrate the benefits of diversification. They are different from arithmetic averages of investment performance calculated for a subject time-period in that, by their construction, they operate at lower levels of investment risk than that calculated as a simple time-period average. This construction advantage comes from treating the index population as a portfolio and calculating its investment risk as the variance of the average periodic returns for that portfolio, rather than as the average of the variance in periodic returns existent among the population of the portfolio for a time period.

There exist several commercial providers of databases that calculate “investment-objective” and “market-category” averages for investment returns and risk over specified time-periods (for example, the average of the 3-year average of periodic returns and the average of the 3-year standard deviation of periodic returns for the market-category population of Large-Cap mutual funds offered by Steele Systems, Inc.). The construction of these averages, as opposed to the construction of an index portfolio is based on taking a time-period average of the population”s average return and risk. This methodology could be easily applied to calculating broader market-sector averages, as well, as illustrated by the point labeled “sec avg” in FIG. 3-7. The resultant calculation, however, would not be indicative of the level of investment risk from holding a diversified portfolio within the market sector. Rather it would be a measurement of probability, namely, the resultant level of risk from selecting one investment from the market-sector at random.

Averages for investment return and investment risk are usable benchmarks of investment management performance, but not the most critical that could be constructed and, unfortunately, are measures whose value has been denigrated over time by a series of academic studies written to demonstrate that a mutual fund manager selected at random from a market sector cannot outperform a primary-market index from that market sector.

The purported purpose of these academic studies has been to compare the efficiency of an asset class population of mutual funds to that of a primary-market index. These studies appear to be somewhat misguided, however, in that they do not consider the effect of holding the fund population as a portfolio, which is the analogous situation to the construction of the primary-market index used as the study benchmark, but rather calculate time-period averages for asset class performance. The calculation of time-period performance averages for a fund population represents the performance expected from selecting a fund at random from the population. It is a statistical measurement of chance not an indicator of the performance characteristics embodied by the entire population. The effect of these studies is to damage the standing of a fund asset-class performance average as a benchmark of investment management performance. If this asset-class average cannot outperform a primary-market index then it is lacking as a critical benchmark.

The advantage of holding the population of an asset class of funds over holding a single fund selected at random is in its lower volatility in times of market transition. This makes an asset class performance benchmark constructed as an index, namely the measure of holding the class population, a superior benchmark for evaluating portfolio manager performance at providing for market-sector level diversification. As shown in FIG. 8, this superiority is demonstrated in time-periods encompassing a change in market conditions. Differential return is the vertical distance of a point from the equilibrium line on a mean-variance chart. It measures the strength of an investment”s performance relative to the sector-average.

The chart mark of FIG. 8 illustrates the average investment return for the S&P500 Index, a primary-market index associated with the Above Average Risk market-sector, over successive 3-year time periods from 1991 to 2001. The change in successive 3-year investment returns for the S&P 500 Index represents the change in the phases of a market cycle for the market sector in which the funds of the Above Average Risk asset class operate.

The bars marked 12 indicate successive 3-year periods where there is little market change; bars marked 14 indicate an upward trend and bars marked 16 indicate a downward phase of the cycle.

The narrow bars marked 18 on the chart indicate the differential return for the market-sector index portfolio in those periods. The general trend is for the differential return to increase dramatically in time-periods of market change, which is an indication of the benefits of holding a diverse portfolio over a randomly-selected fund.

FIG. 3-7 illustrate the concept of investment risk in terms of absolute periodic returns variance, which is the standard deviation of an investment”s periodic returns around their average. FIG. 8 uses the measure of differential return, which is a measurement of relative investment performance derived from this absolute measure of investment risk. There exist other measures of investment risk for market-sector populations of investments. The most prominent among these alterative measures is known as “beta” and is the measure of the variance of an investment”s periodic returns relative to the pattern and level of the variance of the periodic returns for a benchmark representative of the average risk within an asset class or market sector. Beta is a measure of “relative” periodic returns variance and the measure of relative investment performance derived from this risk measure that is analogous to the measure of differential return is known as “alpha”. In an asset class that has been structured under the tenets of MPT, the measurements of absolute and relative investment risk are the same and can be used interchangeably. In practice, however, the industry views each measure has having unique qualities. This present method of creating a market-sector performance index has been tested under both regimes and works as well using either risk measure.

### SUMMARY OF INVENTION

The present invention preserves the advantages of prior art methods for creating market-sector level investment portfolio performance indices. In addition, it provides new advantages not found in currently available methods and overcomes many disadvantages of such currently available methods.

The invention is generally directed to a novel method for creating investment performance indices. More specifically, the present method is well-suited for creating investment performance indices on the market-sector level.

The method of generating a market-sector level index includes the steps of acquiring data for a population of secondary-market securities or other investment types whose operation mirrors that of an investment manager holding a diverse investment portfolio, and generating a contiguous series of the measurement of periodic investment return for that population of investments. The population of investments is divided into market-sector groups whose pattern and level of past periodic returns has been uniquely different as stipulated under the tenets of Modern Portfolio Theory. The period-returns average is calculated for each returns period and each market-sector group population. These market sector group populations are known as “asset classes”and “population-comparison” statistics are created from the average periodic returns of each asset class. Conventional measures of “index-comparison” statistics are also calculated. These measures of index value are preferably calculated using the formula of: [(ending value-preceding period)*(1+(average periodic return-current period/100))]=[ending value-current period]. As a result, the present invention solves the aforementioned problems associated with the prior art.

It is therefore a principal object of this invention to provide a method for generating a market-sector level index.

It is also an object of the invention to provide a market-sector index using populations of securities that can judge the efforts of portfolio managers.

Another principal object is to provide a method to generate an index benchmark to evaluate the performance of investment managers in selecting a portfolio of investments within a market-sector.

### BRIEF DESCRIPTION OF DRAWINGS

The novel features which are characteristic of the present invention are set forth in the appended claims. However, the invention's preferred embodiments, together with further objects and attendant advantages, will be best understood by reference to the following detailed description taken in connection with the accompanying drawings in which:

FIG. 1 is a mean-variance graph that plots investment performance as a function of the average of a series of periodic investment returns (y-axis) and the variance of those periodic returns around their average (x-axis);

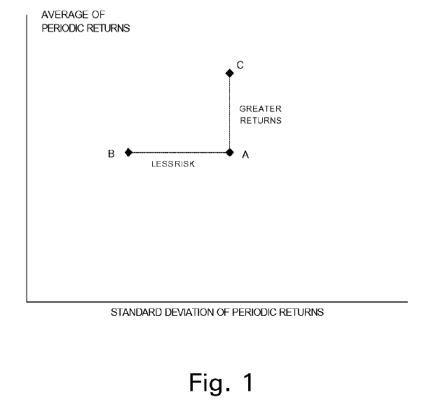

FIG. 2 is a chart showing the interaction of the three processes of managing an investment portfolio including 1) asset allocation, 2) market-sector diversification and 3) investment selection.

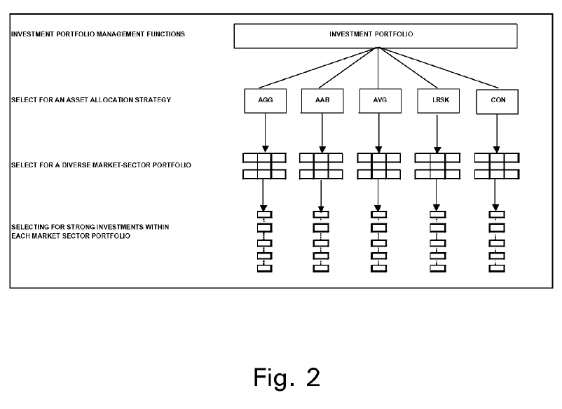

FIG. 3 is a graph of the average of periodic returns versus the variance of periodic returns thus illustrating the range of investment performance for an asset class population of investment managers within a market-sector to show class averages for population average returns and returns variance as the point labeled “sec avg”;

FIG. 4 is a graph of the average of periodic returns versus the variance of periodic returns indicating, as the point labeled “sec port”, the investment performance for an asset class population of investment managers held as a portfolio, which is the key attribute of construction for an index of market-sector investment portfolio performance;

FIG. 5 is a graph of the average of periodic returns versus the variance of periodic returns illustrating, as the point labeled “prime-sec index”, the characteristic location of the investment performance of a primary-market index in relation to an asset class population of investment managers operating within a market sector;

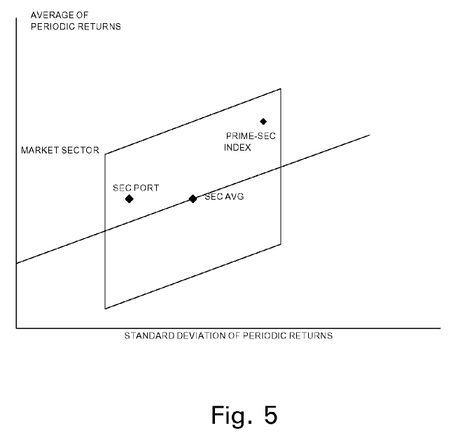

FIG. 6 is a graph of the average of periodic returns versus the variance of periodic returns indicating the location of the investment performance for a population of narrow indices representative of market-category subsets of an asset class and the index of market-sector investment portfolio performance for the Above Average Risk (AAB) market sector over a phase of a market cycle;

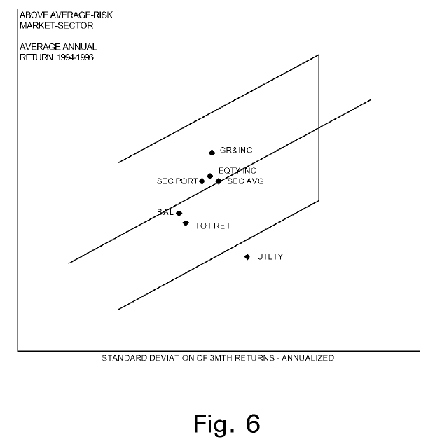

FIG. 7 is a graph of the average of periodic returns versus the variance of periodic returns indicating the location of the investment performance for a population of narrow indices representative of market-category subsets of an asset class and the index of market-sector investment portfolio performance within the Above Average Risk (AAB) market sector over a subsequent phase of that market cycle;

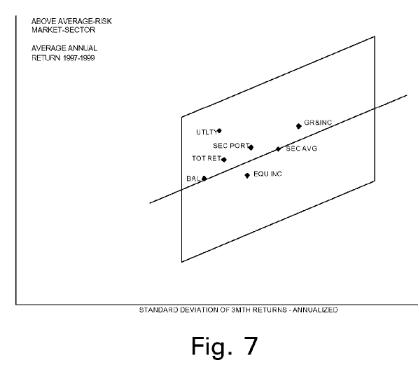

FIG. 8 is a chart of the investment performance of the index of market-sector investment portfolio performance relative to the sector average performance for an asset class population of investment managers operating within the Above Average Risk (AAB) market sector over a series of market cycles from 1991-2001;

FIG. 9 is a chart of the ending values, as of June 2002 for the unweighted index of market-sector investment portfolio performance, weighted index of market-sector investment portfolio performance and associated primary-market index (S&P Market Index) for an asset class population of investment managers operating within the Above Average Risk (AAB) market sector over a series of market cycles from 1991-2001; and

FIG. 10 is table of mutual funds divided into market and investment-objective and market-sector categories.

### DETAILED DESCRIPTION

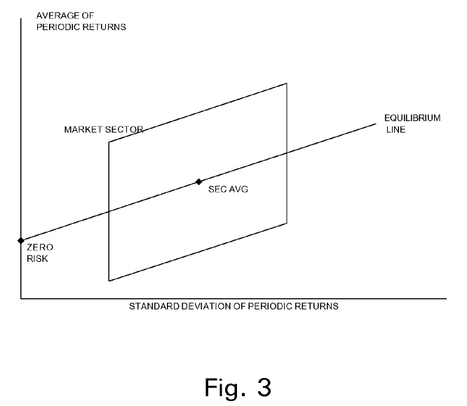

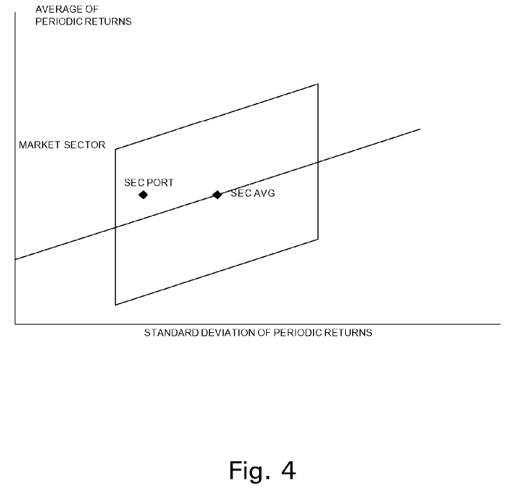

As best illustrated in FIGS. 3 and 4, the present invention is a process for generating such a market-sector level index. The method of the present invention takes as its basis populations of mutual funds grouped into as a small number of broad market-sectors that have been constructed under the tenets of MPT. Analogous to the methods employed for other indices, the average periodic investment return for each population is calculated to accumulate a contiguous series of these average periodic returns to create an index measurement. This contiguous series of periodic-return averages is used to generate measurements of investment return and investment risk for various time-periods appropriate for the comparison of these benchmarks against the performance of a portfolio manager providing for a diversified risk at the market-sector level of an investment portfolio. They are also used to construct statistics of index value of the same types as published for existing primary-market indices, such as the S&P500 Market Index and Lehman Brothers Aggregate Bond Index.

In FIG. 3, the range of investment performance for a population of investment managers that are managing investment portfolios made from investments within a market-sector can be represented by the parallelogram. An average of investment return and risk can be calculated for this population and marked as “sector average”. A line can be drawn from a point of zero risk, through the sector-average. This line, constructed under the tenets of the Capital Assets Pricing Model (CAPM), is generally recognized as a representation of the average investment performance across the range of risk existent within this asset class of investment portfolios (equilibrium line).

In FIG. 4, if a point marking an investment resides above this equilibrium line it is said to possess greater than average investment performance. A point residing to the left of the sector-average indicates an investment of below-average risk. The performance of an asset-class portfolio of the mutual funds within a market-sector population (sector portfolio), is designated as the index of market-sector investment portfolio performance and consistently resides to the left and parallel to the point of investment performance marking the sector average. This makes this index measure a consistent benchmark with which to judge an investment manager”s efforts to provide a strong and diversified market-sector portfolio.

This process is unique from prior processes to provide for a market-sector index using populations of primary-market securities in that its use of mutual fund populations generates results that are specifically germane in regards to judging the efforts of portfolio managers. It is unique from investment-objective and market-category indices of secondary-market securities in that it calculates averages from an entire asset class of those funds within a market sector to provide a measurement that is relevant to judging the efforts of diversification efforts at the market-sector level.

The invention is a process to generate an index benchmark to evaluate the performance of investment managers in selecting for a portfolio of investments within a market-sector. This process generates a series of benchmarks that provide a measurement of both the strength of investment returns, as well as, adequacy of diversification for a portfolio relative to its market-sector peers.

The Process Employs the Following Steps:

(1) Acquire the data for generating a contiguous series of the measurement of periodic investment return for a population of investments whose operations mirror that of an investment manager holding a diversified investment portfolio.

Investment return is the net change in the value of an investment over a period of time, plus any distributions of value made to holders of that investment during that time period. Indices are commonly calculated on the basis of the daily investment return of a population of investments (periodic returns). By way of example, indices illustrated herein are calculated on the basis of quarterly periodic returns. Resources may be employed to acquire data on a daily basis. The advantage of shorter returns periodicity is in the “diversification effect” on the level of investment risk generated by the index, which means the shorter the time-period of periodic returns used to calculate measures of longer-term investment performance the greater the effect of holding a diversified population on lowering the long-term investment risk calculated for that population.

In accordance with the present invention, populations of open-ended investment companies (e.g. mutual funds) have been selected as the population of investments that best mirror the operations of an investment manager holding a diversified portfolio. Such investments are discussed herein by way of example. Other types of secondary-market securities may be used that possess the same operating characteristics as mutual funds. Mutual fund managers have many of the same operating constraints concerning liquidity and asset concentration, as do other managers of investment portfolios. The value of their portfolios is also calculated on the basis of book value, rather than market value. Because of these factors, their pattern and level of changes in periodic returns better follows that of an investment manager operating a privately held portfolio than do indices based on primary-market securities or market-valued secondary-market securities.

The data employed is acquired from a reseller of the Micropal mutual fund performance data, Steele Systems, Inc. Quarterly market-category and investment objective performance statistics from 1962, and individual-fund statistics from 1992 to date have been accumulated.

(2) Divide this population into market-sector groups whose pattern and level of past periodic returns has been uniquely different as stipulated under the tenets of Modern Portfolio Theory. These market-sector groups of mutual funds are known as asset classes.

Creating a population of allocation-strategy alternatives under the tenets of Modern Portfolio Theory and the limits of commonly available computing capacity requires that these market-sector groups be limited to a small number of sectors that cover all available markets. For example, calculating the number of alternatives that can be constructed from the combination of (4) market-sectors in 5-percent increments yields a population of 1,771 alternatives (7) market-sectors yields a population of 219,777 alternatives and (10) market-sectors, 7,754,510 alternatives.

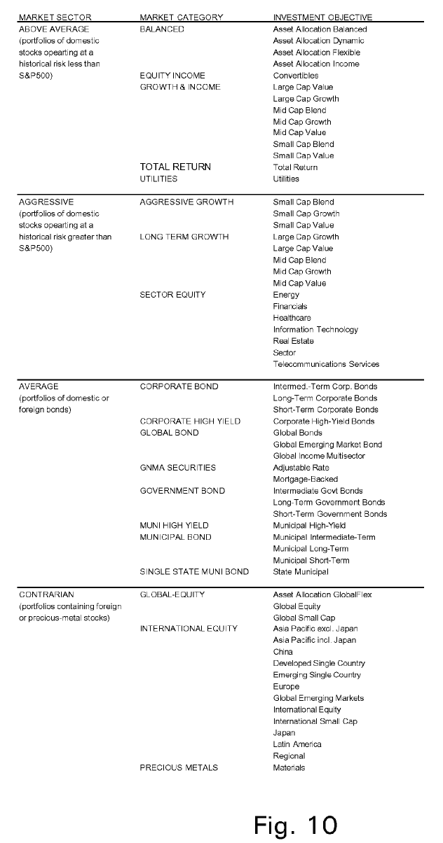

There exist commercial providers of invest-objective and market-category fund indices. Micropal, a subsidiary of Standard and Poors is one such provider. Their database lists (17) market-category and (61) investment-objective indices. These are narrower population divisions than can be accommodated in a strategy based on MPT. The funds in those market-category indices into (5) market-sectors are combined based on the tenets of MPT, as shown in FIG. 10. Those (5) market sectors yield a population of 10,626 allocation-strategy alternatives when combined in a portfolio in 5-percent increments.

(3) Calculate a period-returns average for each period and each asset-class population.

The database employed in the present invention consists of quarterly returns for mutual funds calculated as a continuous series beginning January 1962. That equates to 160 quarterly return averages for each of (5) asset class populations. It is usual to calculate average periodic returns as weighted average returns for indices. For primary-market indices the weight is the period-ending market value of each security for mutual funds, and other book-valued secondary market securities, it is the period-ending net asset value of each security.

As a performance benchmark, a weighted average is indicative of the market demand for the securities in the market-sector. In studies of the relative strength of the markets for primary-market and secondary-market securities, this measurement is appropriate for calculating and comparing populations of investment alternatives. In the evaluation of investment portfolio managers, however, this measure is not particularly relevant.

Another way to construct a market-sector average for periodic returns is as an un-weighted average of the periodic returns for the population within an asset class. In a book-valued market, such as the mutual funds market, this un-weighted measure can be viewed as indicative of market supply the average for the number of purveyors of investment portfolios within the sector. In terms of a benchmark of an investment manager”s efficiency in providing for a diversified market-sector risk, an un-weighted average of the performance characteristics of an asset class population of mutual funds is akin to “holding the market”, which is the act of using every diverse-portfolio strategy available in the sector. The action of holding the market is logically the most conservative strategy available for asset diversification. This attribute of construction ensures the stability and consistency of the index of market-sector investment portfolio performance as a benchmark measure of investment manager performance.

Because of the high mortality rate of newly-formed funds, some type of filter is a prudent addition for an un-weighted average. For the database used in the method of the present invention only those funds are selected with at least five-years operations for the populations to calculate an un-weighted average for each market-sector. These “mature” funds account for over 70% of the net assets of the funds market.

Another aspect of the construction of periodic-return averages should be considered, as well, in regards to the use asset class populations of funds to index portfolio-manager performance. Many fund companies operate multiple classes of the same fund each different in only the expenses charged for management and administration.

Fund expenses are netted against the gross return generated by the fund portfolio and for those fund classes used within 401 (k) plans, for example, these expenses can be two to three times that of the non-401 (k)-plan classes of the fund. Populations of funds used to generate a market-sector average periodic-return should be segmented by class, whenever significant differences in fund-expense exist and portfolio managers should be evaluated against like-expense peers.

(4) Create a population of “population-comparison” statistics of relative investment performance for managers of market-sector investment portfolios using the contiguous series of average periodic returns for the asset class population of funds to create longer-term measures of investment performance characteristics.

Population-comparison statistics can include measures of average return and variance of periodic returns generated for analysis periods of various lengths from the contiguous series of average periodic returns for a performance index population of each market sector that is made from an asset class population of funds. An straight line can be drawn from a point of zero risk through the point of average return and returns variance for this index population on a mean-variance graph, and the performance of investment managers in implementing a diversified market-sector portfolio over the analysis period be measured against this equilibrium line. Such a comparative analysis would be a more rigorous measurement of a manager”s efficiency than conventional methods that use an equilibrium line drawn through a point of the averages of average return and returns variance for the class population. It would also benchmark that manager”s efforts against a consistent standard, which is the most conservative diversification alternative available within the market sector over the analysis period.

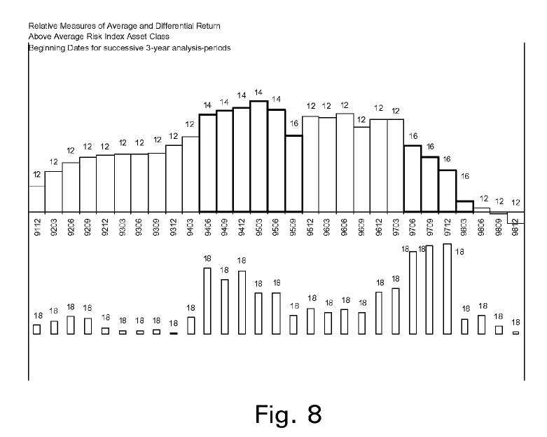

The power of this index of market-sector investment portfolio performance to benchmark the success of an investment manager in providing for market-sector diversification is demonstrated by such comparative statistics. The value of diversity appears during time-periods when market conditions change. Plotted on a mean-variance graph, the investment performance of the investment portfolio index consistently betters the market-sector average (the measurement of a fund selected from the market-sector population at random), by virtue of its lower periodic-returns variance (investment risk). In time-periods of market change, this advantage is heightened as shown in FIG. 8.

Create statistics of “index-comparison”, which are a series of index values for the pattern and level of cumulative periodic investment returns for the performance index population of each market sector. Such a index-comparison statistic is commonly denominated to begin at 100, i.e. the value of the index at its start-date is 100. The change in the ending value of the statistic is calculated for each subsequent time-period by multiplying the value at the end of the preceding time-period by the index population average for periodic returns of the current period, using the equation:

[(ending value-preceding period)*(1+(average periodic return-current period/100))]=[ending value-current period]

The conventional use of an index-comparison statistic is to generate a number that can be published on a periodic basis to communicate the relative pattern and level of the investment value of the index population and, by inference, the value of its associated market sector of investment portfolios. For example, the S&P500 Market Index is an index of a population of primary-market securities whose pattern and level of investment value is currently associated with the index-comparison statistic of the number 1,000. This number 1,000 represents the accumulated investment returns for the population of securities within that index since its inception and initial index value of 100.

There exist a group of popular primary-market indices that can be associated with the asset-class populations of mutual funds within the (5) market-sectors of the present process by virtue of exhibiting a uniquely similar pattern of periodic-returns variance in prior periods. Because of the current interest within the industry in comparing the long-term performance of investment managers with their associated primary-markets, the method of the present invention preferably synchronizes the two sets of performance data through a comparison using commonly denominated index-comparison statistics for an associated primary-market index and an index of market-sector investment portfolio performance created from an asset class population of funds. The process of creating commonly denominated index-comparison statistics is implemented either by setting the initial value of the index of market-sector investment portfolio performance at the level of its associated primary-market index in cases where the primary-market index existed prior to the start date of the series of contiguous periodic returns available for the portfolio performance index, or setting the start date for the portfolio performance index to coincide with the start date for the primary-market index in cases where the primary-market index was initiated after the series of contiguous periodic returns available for the portfolio performance index began.

The resulting index values, as of June 2002, are listed below:

Resulting Index Values:

| | | | | Ending |
|---|---|---|---|---|
| | | | | Value |
| | Associated | | Ending | Primary- |
| Fund Market | Primary-Securities | | Value-Sector | Market |
| Sector | Index | Start Data | Index | Index |
| Aggressive | NASDAQ | Mar-1971 | 3,068 | 1,444 |
| | Market | | | |
| Above | S&P500 | Jan-1962 | 941 | 1,089 |
| Average | Market | | | |
| Average | Lehman | Jan-1973 | 715 | 1,158 |
| | Aggregate | | | |
| | Bond | | | |
| Low-Risk | Yield 90day | Jan-1974 | 672 | 688 |
| | Tbill | | | |
| Contrarian | MSCI-EAFE | Jan-1970 | 715 | 1,104 |

These index-comparison statistics can also be calculated with common start dates and initial values that are based on a specific analysis period. The relative growth in value between a population of investment managers managing for a diversified portfolio in one market sector can be compared to an analogous population of investment managers managing a portfolio within another market sector or a collection of market securities over a common time period by comparing the ending value of their index-comparison statistics generated by an asset-class population of funds making up the index of investment portfolio performance for their respective market sectors. For this type of comparison statistic, the portfolio performance index having the largest ending value indicates the market sector of investment portfolios generating the strongest investment returns the analysis period.

The resulting index values, for a 3-year analysis period ending as of June 2002, are listed below:

Resulting Index Values:

| | | | | Ending |
|---|---|---|---|---|
| | | | | Value |
| | Associated | | Ending | Primary- |
| Fund Market | Primary-Securities | | Value-Sector | Market |
| Sector | Index | Start Date | Index | Index |
| Aggressive | NASDAQ | June1999 | 89.67 | 54.47 |
| | Market | | | |
| Above | S&P500 | June1999 | 87.78 | 71.68 |
| Average | Market | | | |
| Average | Lehman | June1999 | 116.35 | 126.34 |
| | Aggregate | | | |
| | Bond | | | |
| Low-Risk | Yield 90day | June1999 | 112.95 | 113.45 |
| | Tbill | | | |
| Contrarian | MSCI-EAFE | June1999 | 88.77 | 81.75 |

Test Data

Providing for a diversified risk at the market-sector level involves the obvious task of assembling a portfolio of investments that represents a broad range of risks available within that market-sector. It also entails a less obvious task of providing for the necessary liquidity to sustain the integrity of the portfolio in times of market distress. Since market performance tends to move in cycles over time, this second task is integral to any practical application of portfolio management.

Mutual fund managers are the largest group of portfolio managers involved in the practical application of portfolio management at the market-sector level, and are a group for which the greatest amount of accurate and complete performance data exists in the public record. They represent a stable and unbiased sample population of the population of investment managers operating investment portfolios at the market-sector level.

The test data, in accordance with the present invention, entails calculating market-sector averages of quarterly returns (periodic return averages) for an asset-class population of mutual funds since 1962. This data is used to create a set of market-sector indices analogous to those indices existing for populations of primary-market securities. The performance of these indices has been compared to that of indices of primary-market securities that can be associated with these market-sector classifications, as well as the populations of investment-objective and market-category indices contained in each sector. Additionally, arithmetic averages for investment return and risk have been calculated for each asset-class population, and the investment performance represented by those averages compared to that of the market-sector indices.

The objective of these tests is to verify the strength of the market-sector indices as measures of market-sector performance against other alternatives available in the market. In general, the tests demonstrate and support the contention that performance statistics generated from market-sector indices are superior alternatives to the evaluative statistics that can be generated from both indices made from populations of primary-market securities and of narrowly-defined subclasses of market-sector funds in representing the performance of the market-sector, and that the market-sector indices are a more revealing indicator of the performance of a diverse holding of market-sector investments than is the arithmetic averages calculated for that market sector.

These indices will be recalculated when additional data is available. As a general rule, the shorter the periodic periods used to calculate the index, the more pronounced the benefits from holding a diverse portfolio become over a time-period analysis. Other securities-indices are calculated from daily periodic returns, and these can be, as well.

There exist several options for calculating the weight of individual funds within the indices. Most primary-market indices are “weighted-value” indices; the contribution of each component security to the periodic returns of the index weighted by its market value. Changes in market value are indicative of investor demand, and so such weighted indices reflect market expectations, as well as the intrinsic value of the investment. This type of valuation can be used in conjunction with a population of mutual funds and populations of other types of book-valued secondary-market securities by weighting the periodic returns calculation with each fund”s ending-period net-asset value. The performance of such a weighted index is thus “flavored toward” the market demand for various segments of the market-categories and investment philosophies present within the market-sector population.

Another option is to produce an un-weighted index, one less representative of current market expectations and therefore, potentially less volatile. For an un-weighted index, some accommodation must be made for the wealth of new funds that “spring up like wild flowers” at each turn of the market cycle and that are notorious their lack of persistency as fashions fade. I limit my un-weighted index to those funds that have been in existence at least five years a group that represent over 70% of existing fund-market assets.

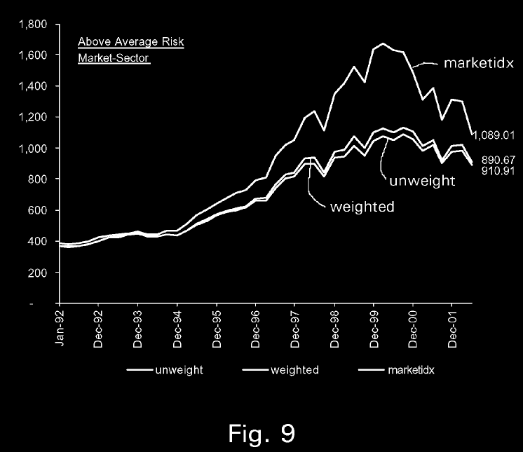

Both options have been tested against other market-sector and primary-market index alternatives and they both suffice for providing a more stringent and fairer measurement of investment portfolio diversity and performance. As seen in FIG. 9, over the last forty years, there has been very little difference in performance between the two types of calculations. There has been historically much argument over the relative benefits of weighted and un-weighted indices. My findings in regard to asset-class populations of funds are that there exists little difference in the results achieved by either method. In the chart of FIG. 9, the ending values as of June 2002 are shown for the un-weighted market-sector-index, weighted market-sector index and associated primary-market index (S&P500 Market Index) made for an asset class of mutual funds within the Above Average risk market sector.

In accordance with the present invention, the un-weighted index for comparing investment manager performance is preferred in light of prior studies regarding rational selection behavior. Mutual funds operate as a book-valued market and size differences between funds can become enormous due to temporal conditions of investor demand. Within several of the market-sector populations there exists up to an 80:1 size ratio between the 10-largest funds in a population and the average for their smaller peers. Since size has been shown not to be an indicator of future differences in investment performance, it would not be rational for an individual investment manager to select among a supply of market-sector diversification strategies on the basis of asset-weighted size.

For the present process, the preferred method of measuring periodic return variance is as the absolute level of variance, which is the standard deviation of a contiguous series of periodic returns around the average value for this contiguous series. There exists at least one other measurement method within the industry, the most prominent of which is known as “beta”, or the level of periodic returns variance relative to the level and pattern of periodic returns variance for an associated benchmark measure. This process will work equally as well for and applies to beta and other alternative methods for calculating investment risk.

Planned Use for the Invention

The planned use of this invention is to generate a set of investment performance benchmarks for use in evaluating the performance of investment managers or other investment advisors offering the function of investment selection against the performance derived from a population of investment managers within a limited set of broadly-defined market-sectors. Population-comparison statistics will be constructed from the periodic-returns data used for those indices, and those measures offered as benchmarks to evaluate an investment manager”s or advisor”s success in providing for an adequately diversified risk at the market-sector level of an investment portfolio.

These measures can be used to evaluate either those managers engaged in constructing market-sector portfolios from primary-market securities or managers assembling such a portfolio from secondary-market securities and other portfolio collections of primary-market securities existent within a market-sector (for example, a manager tasked with acquiring one or more mutual funds within a sector).

The calculated population-comparison measures of investment return and risk can also be used within the broader context of processes to evaluate the management of investment portfolios, forming the basis for evaluating the second management function, namely, diversification at the market-sector level, as well as providing a framework with which to make distinctions in the evaluation of the first and third functions, as well. In this regard, the benchmark can act as a proxy for the actual investments selected in a proforma analysis of the effectiveness of the selected asset allocation strategy or the strength of the individual investments relative to their sector peers.

Index-comparison statistics can also be generated from the periodic returns data used for these indices to produce benchmarks that compare the relative pattern and level of accumulative investment returns for investment managers operating investment portfolios within a market sector with the value generated by investment managers operating in other sectors and between market-sector managers and index populations of primary-market securities.

These and other modifications and variations occurring to those skilled in the art are intended to fall within the scope of the appended claims.

1. A method of generating a market-sector level index of investment portfolio performance, comprising the steps of:
acquiring data for a population of investments;
generating a contiguous series of the measurement of periodic investment return for the population of investments whose operations mirror that of an investment manager holding a diversified investment portfolio;
dividing the population of investments into market-sector groups whose pattern and level of past periodic returns has been uniquely different as stipulated under the tenets of Modern Portfolio Theory;
calculating an average of the population period-returns for each returns period and each market-sector group;
creating index-comparison statistics for each market sector; and
generating population-comparison statistics for each market sector from periodic returns data of the market-sector group.

2. The method of claim 1, wherein the index-comparison statistics are calculated using the formula of: [(ending value-preceding period)*(1+(average periodic return-current period/100))]=[ending value-current period] and the start date and beginning value is set to coincide with earliest available initial date and the initial-date index value for an associated primary-market index.

3. The method of claim 1, wherein the index-comparison statistics are calculated using the formula of: [(ending value-preceding period)*(1+(average periodic return-current period/100))=[ending value-current period] and the start date and ending dates for the compared indices are set to common values and the initial index value is set to 100.

4. The method of claim 1, wherein the population-comparison statistics are calculated using an equilibrium line structured under the tenets of the CAPM.

5. The method of claim 1, wherein the populations of investments are comprised of asset classes of book-valued secondary-market securities.

6. The method of claim 1, wherein the populations of investments are comprised of asset classes of mutual fund securities.

7. The method of claim 1, wherein the periodic returns are calculated on the basis of quarterly periodic returns.

8. The method of claim 1, wherein the periodic returns are calculated on the basis of daily periodic returns.

9. The method of claim 1, wherein the variance in periodic returns is calculated as its absolute value, known as the standard deviation of periodic returns around their average value.

10. The method of claim 1, wherein the variance in periodic returns is calculated in terms of its value relative to the pattern and level of the variance in periodic returns for a benchmark measure, otherwise known as beta.

11. The method of claim 1, wherein the population of periodic returns data comes from an average of a population of investment alternatives combined as four market-sectors.

12. The method of claim 1, wherein the population of periodic returns data comes from an average of a population of investment alternatives combined as- five market.

13. The method of claim 1, wherein the population of periodic returns data comes from an average of a population of investment alternatives combined as seven market-sectors.

14. The method of claim 1, wherein the population of periodic returns data comes from an average of a population of investment alternatives combined as ten market-sectors.
